(19) United States
(12) Patent Application Publication
(10) Pub. No.: US 2011/0184826 A1
(43) Pub. Date: Jul. 28, 2011

(54) METHOD AND SYSTEM FOR SELLING CONSUMER SERVICES

(75) Inventors: Yuri Salamatov, Krasnoyarsk (RU); Vadim Zamuraev, Verkhnyaya Salda (RU); Alexander Ivanov, Moscow (RU)

(73) Assignee: InnovatioNet, Palo Alto, CA (US)

(21) Appl. No.: 13/020,343

(22) Filed: Feb. 3, 2011

(51) Int. Cl. G06Q 30/00

(52) U.S. Cl. 705/26.1

(57) ABSTRACT

A system for selling consumer services according to the service satisfaction is presented. The system includes delivering the service, determining an emotional state of the consumer before, during, or after consumption of the service, setting a price for the service based on the emotional state of the consumer, and receiving a payment from the consumer.

### FIELD

The present invention relates to data processing and, more specifically, to pricing of consumer services in accordance with a level of consumers' satisfaction from consumption of these services.

### BACKGROUND

Consumers and sellers traditionally exchange services for money through one of several methods. In the most common of these methods, the seller sets the price, and the consumer either accepts or rejects that price (for example, retail, or most classified ads). In another common method, the consumer and seller agree on a price (for example, at a flea market, or in a classified ad which includes the words “or best offer”). Sometimes consumers compete and the highest price offered wins (for example, a standard auction, a reverse auction, or a Dutch auction). Sometimes sellers compete for a given consumer (for example, a “wanted to buy” classified ad). In all of these cases, the consumer and seller agree to the price and payment terms before the services are provided. If an agreement on price and other terms cannot be reached, the transaction does not occur.

However, for a variety of reasons, some transactions cannot be carried out altogether or be completed optimally. For example, consumers may be uncertain about the value of the service(s) they are considering and may therefore be reluctant to make the purchase. Often a consumer chooses a service in reliance on the reputation of the service's provider, its popularity or some other factor. This is the reason why many of the new or little-known services, as well as their providers, are ignored. In some cases, the value of a service to a given consumer cannot be determined until it is rendered. For example, a consumer cannot know in advance whether he will like or dislike a new film. Therefore, the consumer first analyzes the available information about the movie, such as the names of its producers, actors, its genre, etc. If based on this information the consumer believes that he will not like movie, then he will not commit to watching this film. The advertising information may sometimes be deceiving. If the consumer decides to watch the movie relying on such information, he may be disappointed. This problem is especially important to movie theaters, where the consumer pays for viewing. After consumer watches the movie, it becomes clear whether he likes it or not. It is more logical to make the payment after the value of the service maybe estimated, i.e. after viewing the film.

There are currently many competing companies in every niche of the market, which makes it difficult for consumers to choose one service over the other. U.S. Pat. No. 6,578,014 describes a method and mechanism for post-transaction pricing system. The consumer pays the price he deems appropriate after the goods are received. Over time unscrupulous buyers, who almost never pay for goods, begin to experience problems with their purchases as merchants lose interest in trading with them. On the contrary, conscientious buyers do not experience such problems. This invention eliminates the need for negotiations between the buyer and seller. Under this payment system, a person is not afraid to buy an unfamiliar product or service and does not ponder whether to buy it or not. If he does not like the goods, or the goods do not match their description, then he may pay little or not at all. This protects the consumer from false advertising and makes the purchase of goods and services more attractive. This method also allows the little-known producers of goods and services to compete on an equal basis with reputable companies. The disadvantage of this method is that the seller is required to make additional efforts to track unscrupulous buyers, which may not always be feasible. The sellers' losses from trading with unscrupulous buyers can be very significant and unpredictable, which can lead to the demise of some sellers. In this case, the cost of goods and services paid by the consumer is very subjective and cannot express the real value of the goods or services to the consumer.

U.S. Pat. No. 6,107,932 describes a system and method for controlling access to the venue, using the variable tickets. The ticket gives access to the venue and the right to change the right of access. If a ticket is changed, the right of access to the venue of the first owner expires and moves to the next owner. The system monitors the venue access rights, as well as the nature of the rights: whether it is the right to access or the right to change permissions. If the ticket is changed, the system calculates the refund (depending on the time of the change, or the occasion) to the holder of the ticket. In this case, the ticket holder who wants to change the right (deny the right of access to the venue) and get a refund does not need to physically present the ticket to the box office or elsewhere. The tickets are visually inspected at the venue entrance, which does not require complex and expensive equipment. This patent solves the problem of the tickets' return and the receipt of refund without having to physically return them. If the ticket buyers have the ability to easily return the ticket, they would not need to be overly concerned with whether they can get access to the event. This method allows attracting the maximum number of clients, which increases the profits of those who sell tickets.

### SUMMARY OF THE INVENTION

Receipt of pleasure is the main objective of the consumption of many services (products, goods). Such services (products, goods) include, for example, entertainment services (products, goods), such as music, movies, books and games.

Authors (artists) create entertainment services (products, goods). The entertainment services are then given to the owners (operators) of devices and buildings designed to provide entertainment services, and are consumed by consumers. The owner receives compensation in exchange for the pleasure received by a consumer and/or author (artist) receives a fee. The more pleasure is received by a consumer, the larger payment should be received by the owner of the entertainment services devices or buildings, and/or author (artist). Inversely, the less pleasure is received by a consumer, the lesser payment should be received by the owner of the entertainment services devices or buildings, and/or authors (artists).

Any entertaining service represents a collection of media constructs, such as musical phrases, texts, video images, etc. Different media constructs influence consumers differently. Therefore, during the consumption of entertainment services the consumer experiences different emotions and feelings. Sometimes the emotional state changes sharply, sometimes it changes slowly. Thus, in the process of reception of entertaining services the consumer experiences a varying level of a positive emotional state. On the time scale, this level can be undulating, picking, stepping, etc. Positive emotional state can also fall below the neutral level or move into a state of negative emotions.

The neutral level of the emotional state is defined based on average value of measures of the emotional state of the alert person measured during a given amount of time when the consumer does not consume entertaining services and is in a calm state. It is necessary to take into account that the level of a neutral emotional state also depends on the mood of the consumer, the state of his health, age, current environmental circumstances, etc. Therefore, the neutral level is itself variable, it changes periodically, which should be traced and measured during an interval of time.

Measurement of a neutral emotional state can be taken in automatic, semiautomatic or a manual mode. The automatic mode assumes gauging the measurements from sensors during an interval of time (for example, a few minutes), in a familiar (for example, domestic) settings, preferably in the afternoon, from a healthy subject, free of influences of any chemical or biological substances (for example, medicines), without excessive physical, intellectual and emotional tension. The absence of external sources of the information (for example, media systems) is desirable. The gauged parameters (represented by the time graph) are analyzed by the program with the purpose of defining an average level, characteristic of the most common parts of the graph between the peaks and dips.

The semiautomatic mode allows to accelerate the process of defining by engaging the sensors by the subject during the periods of genuine calm state. Such state can be reached by various methods: it is possible to await its arrival, it may be reached by using the self-induced calming techniques, or it may is reached by subject's engagement in activities which have guaranteed calming effects on the subject, such as reading, a leisure walk, a hobby, etc.

The manual mode is possible only when the consumer knows about his personal neutral level and can input it into the device independently. If all fluctuations of the consumer emotional state during reception of an entertaining service are added, it is possible to come up with an estimate of the subject's enjoyment of this entertaining service (product, good). Evaluation of the consumer's emotional state and scoring the entertaining service (production, article) accordingly, has an intrinsic value to all three participants in process of entertaining services' delivery and consumption—the consumer, the owner of the device or a building for the delivery of entertaining services and the author (artist).

The consumer knows that his emotional state is traced during the entire time of consumption of an entertaining service. He/she also knows that he will pay only for the total pleasure received by him—the positive emotions experienced by him/her during the consumption of a service. Therefore, he/she does not experience negative (annoying) feeling for time and money spend in vain if the entertaining service has not delivered the expected pleasure. It also simplifies the decision-making process with respect to consumption of a particular service. This will allow the little-known providers and new services to advance in the market.

The owner of the device or building for entertaining service delivery has an opportunity to obtain the exact assessment of a service by consumers. This will allow the owner to settle with the authors (artists) and/or providers of entertaining services. This owner will have an opportunity to properly arrange for the promotion and advertisement for a given service based on the objectively measured value of the service. Completed evaluations of a set of services (products, goods) by a particular author (artist), will provide this owner with the overall value of the services (products, goods) of this author (artist) to the consumer.

Completed evaluations of a set of services (products, goods) by a number of authors (artists) will provide the owner, or an association of owners, with the overall assessment of consumer preferences within a particular area of entertainment services. Keeping track of changes in consumers' assessment of various authors in various fields of entertainment over time will provide this owner, or an association of owners, with an idea of the direction in which the consumer preferences shift. This will enable the owner(s) to anticipate (predict) which entertainment services the consumers will appreciate the most.

Consumer's selection of, for example, an author, is a random process today. This often creates a “fading star” phenomenon. The process of “forged star” appearance is cumulative—it consists of mass preferences of consumers who, having no objective basis for evaluation, in the first instance choose the authors (artists) who are most popular at the moment. Besides, show business also has no objective basis for evaluation of a change in true popularity of the artist and, therefore, invests in the “reliable sources of the profit”, or, in our case, in the most popular artists. Therefore, the popularity of such an author (artist) can remain high, or even grow, for a long time despite the fact that there can be more talented author (artist) around. Determination of the consumer's emotional state allows for objective evaluation of the author (artist). For example, the combined emotional evaluation of an author (artist) by a group of consumers (family, city, region, country) at a point in time, or over a certain period of time, expressed as an index, will represent the author's (artist's) “popularity index”. This index will be defined automatically and will, therefore, be the objective evaluation, free of any outside manipulation. It can also form a basis for awarding prizes (similar to current “gold” and “platinum” records), awarding national (or other) titles to authors (artists), serve as a reason for immortalizing the artist's name, etc.

In addition, the consumers' emotional evaluation can serve as objective basis for the calculation of revenue for the owners of entertaining service establishments and/or the author's (artist's) fee. The revenue/fee should be proportional to the pleasure received by the consumers. Therefore a payment (or final settlement in the case of an advance payment, for example, a monthly fee) is made after the consumer has enjoyed the entertaining service. The remuneration can be done directly between the author (artist) and consumer, without any intermediaries, by using the Internet for example.

The experts' (fans or professionals) emotional evaluation can serve as a criterion for selection, adjustment and development of beginning authors (artists). Such experts for evaluation of new authors (artists) may be chosen among permanent consumers of a given type of entertaining service. The viability of this method depends only on one factor: the feasibility of measuring the consumer's emotional state, or, more precisely on the feasibility of detecting/measuring a change in the consumer's emotional state. First, it is necessary to specify which changes need to be achieved. It is known, that emotions can be positive and negative. Let us consider the scale of emotions offered by Russell in 1980 (it is quoted by [1]).

TABLE 1
Positive and negative emotions.

| | |
|---|---|
| Strained | Excited |
| Frightened | Agitated |
| Suffering | Admiring |
| Alarmed | Amazed |
| Enraged | |
| Frustrated | Jovial |
| Angry | Happy |
| Sad | Gladden |
| Depressed | Satisfied |
| Gloomy | Pleased |
| Unhappy | Relaxed |
| Bored | Equable |
| Sluggish | Placid |
| Tired | Calmed |
| Sleepy | |

The left column of Table 1 represents the negative emotions, which intensity decreases downwards. In the right column, there are positive emotions, which intensity increases upwards. The borderline between emotive terms “depressed—gloomy” and “satisfied—pleased” is the approximate “zero” (neutral) level for negative and positive emotions respectively.

One of the goals achieved by the method presented herein is the change (correction) of the person's emotional state in the following ways:

(in the left column) transition from the top downward,

(at the foot) transition from the left to the right,

(in the right column) transition from down upwards.

It is necessary that the ways of detection of the person's emotional state demonstrate these changes. Since the emotional state itself has no measuring scale, only the physiological parameters of the human body may be measured. This physiological parameter should be connected to the emotional state and be traced by another person or by a reliable physical device. The known methods of detecting a person's emotional state changes are divided into “contact” and “contactless” categories.

Electrophysiological methods of studying the organic functions based on registration of the biopotentials arising in tissue of a living organism spontaneously, or in reply to external irritation, are well-known. The most widely used methods are the registration of brainwaves (spontaneous electroencephalogram—EEG and the generated (evoked) potential—GP), muscle waives (electromyogram—EMG), skin waves (skin-galvanic reaction—SGR) and heart waves (the electrocardiogram—ECG).

EEG method, which assumes registration of spontaneous bioelectric activity from various sites of a scalp's surface, allows for the direct registering of changes in the brain activity during various experiments. It has applications in studying of physiological correlators of various psychical functions (perception, attention, thinking, memory etc.), studying emotions, external activity (movements, speech) and self-regulation for the evaluation of the current functional states, and in studying the functional asymmetry of the brain. Due to presence of steady individual-specific features, the EEG is widely used in differential psychological and psychophysiological studies. In particular, it is used in studying the general and private properties of nervous system.

GP method implies registration of the biological potentials arising in reply to external influence and in relatively strict time-correlation to it. One of GP's variety is a reaction of rhythm stimulation—following of fluctuations of biological potential behind frequency of rhythmic irritant. GP method is used at studying perception, attention, intellect, functional asymmetry of the brain and in differential psychophysiology.

EMG is used in experiments related to studying impellent acts for the estimation of intensity, localization and time parameters of muscular contraction, in particular in registration of the latent impellent reactions. Registering SGR as involuntary vegetative parameter is most often used for the estimation of shifts in functional state, emotional and orientation response. There are two ways of SGR registration: registering differences in skin potentials (by Tarhanov) and registering of changes of skin resistance (by Fere). Presence of individual-specific features allows for the use of SGR in differential psychophysiology.

For example, [2] proposes to define the emotional tension under the action of a constant electric current of 10-50 mkA. A level of the emotional state is defined by the formula (R1−R2)/R1, where R1 and R2 is the resistance of skin before and after the psychoemotional influence. Two electrodes are placed on a forearm at the distance of 5 cm from each other. An example: the person in normal state (frequency of breath—13 times per minute, pulse—67-69 times per minute, pressure of blood 120/80) has resistance of skin of 60.3 kiloohm at the 25 mkA current. Under the influence of psychoemotional factor, the resistance of skin decreases to 41 kOm. The calculated level of emotional state is 0.32. Under the influence of strengthened psychoemotional factor, the resistance of skin decreases down to 20.5 kOm. The level of emotional state becomes 0.63. The influence of a current strength on the accuracy of definition of the emotional state level (table 2) has been investigated.

TABLE 2
The influence of current strength on an accuracy of
definition of the emotional state level.

| | Skin resistance (kOm) at the | | | |
|---|---|---|---|---|
| | value of current, mkA | | | |
| Parameters | 10 | 25 | 30 | 50 |
| At the rest state | 103 | 60.3 | 51 | 18 |
| At psychemotional | 60.1 | 41 | 34 | 12.2 |
| influence | | | | |
| Level of | 0.32 | 0.32 | 0.33 | 0.32 |
| emotional state | | | | |

ECG is used for the similar purposes as an objective criterion of vegetative shifts in nervous system.

Other method is proposed in [3], where the photo sensor attached to a foefinger, which records the duration of an intersphygmic interval included in the detector of pulse, is connected to the microcomputer using a serial port. The intersphygmic interval varies in a range from 60 ms (state or rest, slackness) up to 3 ms (emotional excitement).

Gas-discharge visualization (GDV), based on known Kirlian effect (“high-frequency photographing”—Kirlian photography), is also a known electrophysiological method. The structure of Kirlian's luminescence of the person's fingers reflects a wide spectrum of the subject's power, as well as psychological and emotional features.

However, it is impossible to distinguish between positive and negative emotions by using the electrophysiological methods. These methods define only the level of excitement. The additional disadvantage of these methods is the need for attaching electrodes and sensors onto the human body. There are also methods of evaluation of the human's emotional state by observing the external displays, such as mimicry, gestures and voice, i.e. contactless.

For example, in [4] the dynamics of height and timbre of the voice, and/or smoothing of wrinkles near nose and lips, and/or change of the size of pupils in the eye, and/or tension of hands, are measured to determine the emotional state.

Since 1995, the laboratory of the Massachusetts Institute of Technology (MIT) has been developing the research program “Affective Computing” (director Rosalind W. Picard) [5]. The features of voice are studied for the analysis of emotional state:
1.—Quality of voice (for example, the hoarse voice can tell about several individual factors, including features of breath);
2.—Velocity of pronouncing (for example, fast speech can mean fear, and slow—disgust);
3.—A feeding circuit and high-altitude diapason (abrupt phrases and the wide frequencies range—anger, narrow range of low frequencies—grief).

It has been noted, however, that it is very difficult to carry out the analysis of intonations. There are no effective method of such analysis to date. At the same time, NEMESYSCO company [6] has developed “Love Detector”, a hardware-software complex, which reveals and analyzes an emotional state of the interlocutor in a dialogue. This device is able to distinguish, allocate and analyze more than 130 parameters of speech, to define a degree of attention concentration, as well as a level of confusion and excitement of the partner. The cost of this device is $100 USD. The “Pocket PC Love Detector” model is intended for pocket computers.

Contactless methods of evaluating the emotional state are also based on the fact that a complex picture of the physical fields carrying the information about biosystem is formed due to life activity around any biological object. There are at least 8 known types of these fields:

1. Thermal radiation in the infrared range of electromagnetic waves;
2. The radiothermal radiation carrying the information about the temperature and time rhythms of internal organs;
3. Low-frequency electric fields with frequencies from 0 up to 1000 fluctuations per second, which are strongly shielded by tissues of the body;
4. Magnetic fields of the same frequencies used for research of the brain;
5. The acoustic signals arising at functioning of the internal organs, muscles, etc. in the infrasonic range, which is lower than a threshold of audibility of a human ear;
6. High-frequency acoustic signals of noise character, connected to possible sources at molecular and cellular levels;
7. Signals of a bioluminescence in the near infrared and near ultra-violet ranges of optical spectrum of the electromagnetic waves, caused by biochemical reactions carrying in the organism;
8. Changes of structure and physicochemical characteristics of environment of the person, which arise at a metabolism between it and an organism at the human movement etc.

[7] proposes to project infra-red radiation of the human body onto a photosensitive surface of a photo sensor. This projection is carried out discretely in time by interruption of the radiation flow falling on a photo sensor with the help of a “obturator”. The constant component of the signal current is removed from the output signal of the photo sensor, while the variable component of the output signal current of photo sensor is passed through the condenser to the input of the amplifier, where it is strengthened and digitized, and the quantitative analysis of the infra-red radiation is carried out according to changes in its parameters over time.

In addition, it is proposed to carry out the measurement of the emotional state based on changes in temperature near the eyes of the person with the help of the high-sensitivity infrared camera (James Levine, [8]).

[9] is designed to detect terrorists at airports. It is known, that the intention to carry out an act of terrorism and the direct preparations thereto causes the majority of executors to experience high emotional tension. This tension is reflected in all psycho-physiologic parameters of the subject terrorist, including the characteristics of his bio-field. This method is achieved by using a system consisting of two subsystems that consistently exchange their feedback: television support and bio-field analysis. System selects objects for observation in a visible range and in a distant infrared range of waves 8-14 microns. The bio-field analysis represents measurement of intensity of infra-red radiation of the person's face and other uncovered parts of the body. If a certain maximum of intensity is detected, a photo is taken in the visible spectrum of light and a signal is sent to the security personnel.

There is also, “The contactless lie detector” [10], which analyzes mechanical movements of the chest caused by breath, palpitation and other physiological processes detected by active radar in a 3-centimeter wave range. It is known that informational value of electromagnetic radiations is not identical. Chaotic radiations in living organisms are the least valuable. More informative are the ordered electromagnetic fluctuations, which and informational value grows with frequency.

In studying processes of the living organisms, the greatest informational value is given to millimetric waves, both because of the very slow speeds of propagation of acoustic-electrical fluctuations in the polarized cellular membranes, and the low energy expenses in stimulation of fluctuation in the resonant frequencies of evaluating the state of system. [11] serves as an example. The method is based on the phenomenon of stimulation of coherent fluctuations in living cells. A special receiver—radiometer of millimetric range of frequencies with sensitivity (10-17-10-18) W/cm—is used to gauge the fluctuations. Zones of projection of bioactive points and Zaharyin-Ged zones on the surface of skin are chosen as the objects of measurement.

It has been established that any region of skin surface carries information on the condition of the whole organism, i.e. a region of the skin surface is a zone of projective reflections of the internal organs. However, different sites have different resolution capability to display of various organs or emotional states. Projective zones, from Zaharyin-Ged's zones down to smaller zones, such as an auricle (the Chinese experts claim the existence of 1000 or more points and zones), may be useful in diagnosing difficult cases.

The results of gauging the electromagnetic radiations in millimetric range of 74 healthy people in the age from 15 to 49 years has been accepted as a norm. Diagnostics of functional and psycho-physiological conditions was carried out on 300 patients.

Measurements of low intensity extremely high-frequency radiation of the human in the zones of a projection of the bioactive points and Zaharyin-Ged's zones on the skin surface were taken using a highly sensitive receiver and the results were subsequently represented by a computer. The received signal was reflected on the screen in the form of spatial-temporal and spectral characteristics, using the Makloren's mathematical transformation.

[12] proposes that a fundamental property of an human organism—bilateral (i.e. double-ended—right and left) symmetry which is defined by duplication of anatomic structures of organism [13], be used to define the emotional state. Bilateral symmetry is connected to functional asymmetry of the brain hemispheres and parts of the vegetative (i.e. regulating the functions of the internal organs) nervous system. In ideal case, (state of rest) functional asymmetry should be close to zero. However, living tissues of symmetric (right—left) organs (or symmetric parts of the organ) have distinguished levels of metabolic processes and microcirculation (blood supply) [14]. Judging the levels of distribution of controllable parameters in the paired points of symmetry of the subject organ allows evaluating the effects of outside influences on the human organism.

The reflexogenic zones of the organism react to influences of external factors with the highest precision and expeditiousness. Such reflexogenic zones include mucous membranes of a digestive tract, upper airways, extra receptive zones of skin, sinocarotid zone etc. This is to say that any external influences (physical, psychical) instantly result in the change of parameters of the digestive tract, structure and frequency of the breath, structure of the blood, etc. All of these zones have reflection (signal) points on the surface of the human body—acupuncture points on the skin.

The following points are chosen:
1. He-Gy point, which reflects the condition of the large intestine and the secretion system, because it is directly connected to the reflexogenic zones of the mucous membranes of the organism, as well as to the metabolic processes in the organism. He-Gy point is located on the back side of the hand at a junction place of the thumb and index finger bones;
2.—carotid nut (sinocarotid zone) which contains chemoreceptors, sensitive to the changes in the gas structure of the blood and baro-receptors, which, react to the changes in arterial pressure—these receptors detect the most precise and expeditious complex reaction of the blood to influences of the external factors; carotid nut is located in the spot where the common carotid artery branches into external and internal carotid arteries and represents those vessels that are supplied with nervous receptors.

In the described method, the condition of tissue at the observed points is gauged by measuring the index of bioelectromagnetic reactivity (BEMR) at these points before and after external stimuli.

BEMR index measurement is based on the ability of the living tissue to transform the electromagnetic fluctuations induced by external electromagnetic fields, namely: geo- and heliomagnetic fields, which are the low-frequency impulse complex modulated fields, most typical to the living organism. As a result of the bioelectric activity of the living tissue when the living organism is influenced by the external electromagnetic fields, the low-frequency pulse complex modulated electromagnetic field in the form of electromagnetic oscillating processes in the living tissue. However, its spectral structure is different from the spectral structure of the influencing electromagnetic field [15]. Besides all layers of tissue take part in the formation of parameters of electromagnetic fluctuations because natural oscillating processes in the living tissue are caused by metabolic processes and microcirculation. Therefore, the parameters of electromagnetic oscillating processes in a living tissue correspond to a certain functional and morphological state of a living tissue [16]. All this facts allow diagnosing the functional and morphological condition of the tissue by analyzing of appearance or disappearance of certain harmonics interacting with the tissue. It was designated “determination of the index of bioelectromagnetic reactivity of living tissues—index BEMR [17, 18].

[19] proposed the new contactless method of evaluation of the human psychophysical reaction to negative and positive situation (emotionally negative and emotionally positive). This is the only method that allows detecting changes in only the positive emotion or only the negative emotion. This detection method is based on using the experimentally obtained dependence between changes in the value of resonant frequency characteristics of psychophysical reaction activity (Δf, Hz) on the time period of influence, during the process of determining of the emotional state (prescription), which describes the process of psychological dilemma.

A certain emotional condition is created by “verbal influence” (the subject tested being instructed to feel a certain way) or by independent mental reproduction of the emotional condition (love, pleasure, anger etc.).

The device for implementation of this method contains:

A sensor (a frequency meter 0.1 Hz-300 MHz),

A generator of electric fluctuations with the possibility of continuous tuning of frequency of oscillating circuit by changing the electric parameters of the piezocrystal included in the circuit;

A piezoceramic transducer based on a piezocrystal of quartz,

A power unit of the generator with a direct current, in the form of a converter of line voltage of an alternating current into a constant one of the lowered value with electronic stabilization of output tension/voltage,

A monitor.

Method of evaluation of a human psychophysical reaction consists of measuring the shift in resonant frequency of a generator circuit by attaching a piezoceramic transducer in the area of energy-informational fields of the person (from 0 up to 1 m) and tracking this shift in frequency while changing the psychophysical condition of the subject by creating this change in the subject by causing him to mentally relate to emotionally positive and emotionally negative situations. The dynamic measurement of resonant frequency characteristics are performed by tracing the frequency shift during the time of impact by a particular attitude setting, which is reflects a particular mood and mental image onto the subject's consciousness, and is accompanied by the change in psychophysical state.

The optimality of the psycho-physiological reactions is evaluated based on the value and the character of distribution (shift in frequency, aside or reduction, of increasing or decreasing the value of resonant frequency characteristics (Δf, Hz) of the system “device—person”). The level of psycho-physiological reactions is evaluated based on its graphic dependence (Δf, Hz) on the time of influences presented in the form of psychogram. Professor I.V. Smirnov's (Psychotehnology scientific research institute, Moscow, [20]) research in the area of psychosemantic probing of the humans is widely known. In particular, his pioneering developments are applied to detecting the exact emotional state. For example, one of his developments has application in the remote detection of terrorists at the airports, based on their emotional state. The technology most suitable to the purposes of the described invention is VibraImage [2-24].

This technology is based on V A Minkin's discovery of the new phenomenon in psychophysiology of a human: complete interrelation of the psychoemotional state with microdisplacement in the human's center of gravity, particularly, in the head. Microdisplacements of the observed points on the person's face are continuously traced by a video camera (built into any technical device, or external) which displacements are then analyzed with the and with the help a software program. This software program detects psychoemotional state of the person at every given moment of time.

Application of VibroImage technology in psychology is analogues to the invention of a microscope for biology. The entirely new world of emotions which can be detected automatically on the level of microdisplacements. Displacement of the center of gravity of a person in the state of balance by a few nanometers reflects the manifestations of conscious ness and subconsciousness, making VibroImage an element of nano-psychology.

Detection of the human psycho-physiological state is a technical problem of biometry. Biometry unites physics, mathematics, medicine and psychology for the purposed of gauging the biological and/or behavioral characteristics of the person for the purpose of personal identification and the psycho-physiological state. The system for remote contactless scanning and identification of human psychophysiological state is based on this discovery.

Vital functions in humans, as well as in living organisms, are connected to the set of periodic processes occurring in the body, such as breath, pulse, sensory systems functioning, etc. The intensity of occurrence of these physiological processes is connected to state of the organism. When the person is calm and relaxed, the frequency of the heart rate and breath is minimal. When the person is excited, the heart rate raises and breath becomes more frequent. Frequency of the human's vibrations reflects the energy profile of his movements, including the mental state, emotions and health.

Four functionally independent groups of the parameters describing various properties—amplitude, frequency, symmetry and vibroimage processing were chosen to characterize the vibroimage.

Efficiency of detecting of psycho-physiological state was confirmed by comparatively testing and measuring the parameters by the established methods (EEG—electroencephalogram, SGR—skin-galvanic reaction, ECG—electrocardiogram) and psychological testing (Bass-Darky, Hend's test and Lusher's test). Provided in the program is the function of detecting the neutral (“zero”) emotional state. Such detection takes (by default) 10 seconds.

The vibroimage technology allows for controlling the person's state in the real-time mode i.e. the change of vibroimage is detected in the same fraction of a second that the state of the person changes. It can be detected with the help of “rapid” parameters of videoimage, for example, parameters defined on a difference between two subsequent frames. Certainly, it is certainly necessary to take into account the possibility of the effect of a random error on the derived result. Increasing the time of collecting the interframe differences allows for improved accuracy and reliability of measurements, however, it complicates the detection of the rapidly flowing processes. The results of human vibroimage research have shown that the optimal time for collecting the interframe differences for evaluating the person's condition by applying the vibroimage technology is about 10 sec.

The user can observe the image, vibroimage and aura of the object on the screen of the monitor. The system also allows to record and process the vibroimage parameters, evaluate the emotional state of the person, as well his health condition. Vibroimage system of automatically monitors the level of emotions and performs lie detection in real-time. Vibroimage system allows analyzing and registering previously recorded videofiles (avi). It also allows performing emotional control of the person using the video-data received from any source. Vibroimage system is capable of analyzing and registering over 20 parameters of vibroimaging and allows the user to adjust system according to the particular goals and to define the required psycho-physiological parameters of the person.

The program of vibroimage includes three independent program modules: the program for processing the live video (VibraImage), the program for viewing recorded video and log files (LogViewer), and the program for viewing and printing of archived recorded vibroimages of patients (VIPrinter). The program VibraImage allows each user who has a computer and a web-camera to carry out his own personal or scientific psycho-physiological research. Researcher working with system has a unique ability to objectively control the psycho-physiological state of his relatives or patients with the help of standard hardware.

### BRIEF DESCRIPTION OF DRAWINGS

The foregoing and other objects, features, and advantages of the invention will be apparent from the following more particular description of the preferred embodiments of the invention, as illustrated in the accompanying drawings in which like reference characters refer to the same parts throughout the different views. The drawings are not necessarily scales, with emphasis being instead placed upon illustrating the principles of the invention.

FIG. 1 depicts a variant of method embodiment for an external construction for the delivery of entertaining services to consumers.

FIG. 2 depicts a variant of method embodiment of entertaining media service.

FIG. 3 depicts a variant of method embodiment of a system for sales of consumer services.

### DETAILED DESCRIPTION

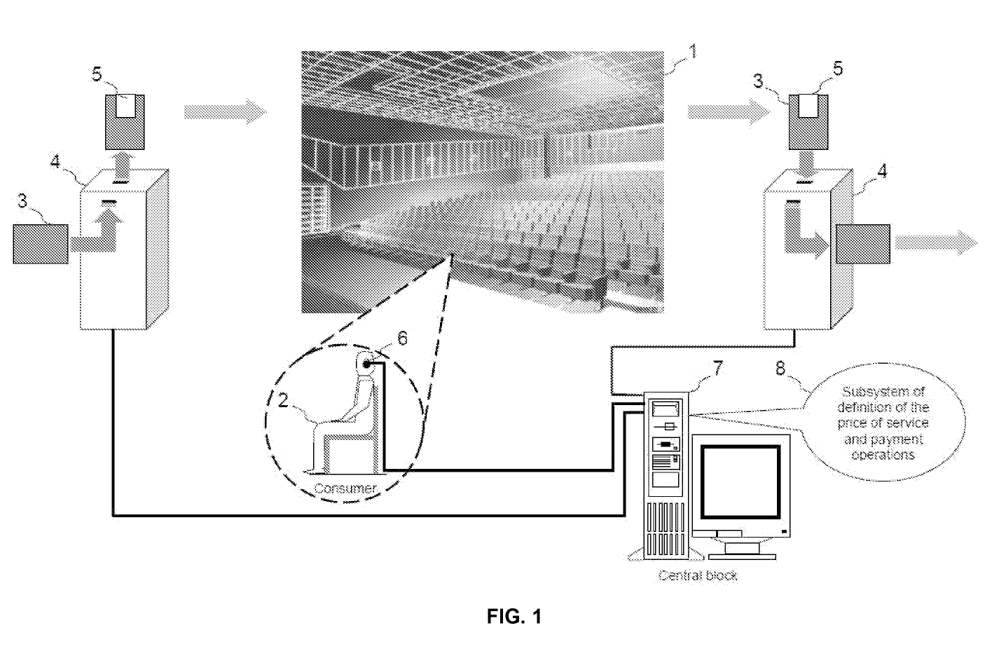

FIG. 1 depicts a variant of method embodiment for an external construction 1 for the delivery of entertaining services to consumer 2.

At an entrance into external construction for delivery of entertainment services 1 consumer 2 shows the data carrier 3 (for example, a universal subscription card for payment for the entertaining services) with the prepaid amount.

Consumer 2 chooses his seat according to a price-list and the plan of construction 1 which indicated which seats are presently empty.

Control device 4 reads the information from the data carrier 3 and writes off the complete cost of consumption of an entertaining service. Simultaneously, a temporary data carrier 5, with the seat number, is attached to data carrier 3, with the purpose of visualizing it to consumer 2.

The choice of a seat and the fee payment can be made via the Internet. In this case, the control device 4 only identifies the consumer and attaches the temporary data carrier 5 to the data carrier 3.

At the exit from construction 1 consumer 2 inserts the data carrier 3 into control device 4, where the final settlement with the consumer 1 takes place in accordance with the price of the service defined by the central block 7, which includes a subsystem for determination of the price of the service and calculations 8.

Simultaneously, the temporary data carrier 5, with the seat number is disposed of The subsystem for determination of the price of a service and calculations 8 carries out the following functions: detecting the emotional state of each consumer during consumption of an entertaining service; monetary settlement with consumers; calculation of the payment to the owner of entertaining service's construction; and/or payment to the author (artist).

If sensor of emotional state 6 is a portable device, it is provided to the consumer 2 at the entrance to construction 1. If sensor 6 is a stationary device, consumer 2 attaches it to his body or clothes at the seat. Sensor 6 also can be built into the seat or into any place in construction 1. The main requirement to the arrangement of sensor 6 is that it should detect the emotional state of the individual consumer 2 to whom it has been assigned.

If consumption of an entertaining service presupposes an impermanent placement of consumer 2 in or about construction 1 (such as in amusement park), the temporary data carrier 5 may then be a remote identifier of the consumer, such as a microelectronic (pocket) device. The neutral level of the consumer 2's emotional state is determined prior to the beginning of consumption of an entertaining service, for example, immediately after consumer 2 establishes contact with sensor of the emotional state 6.

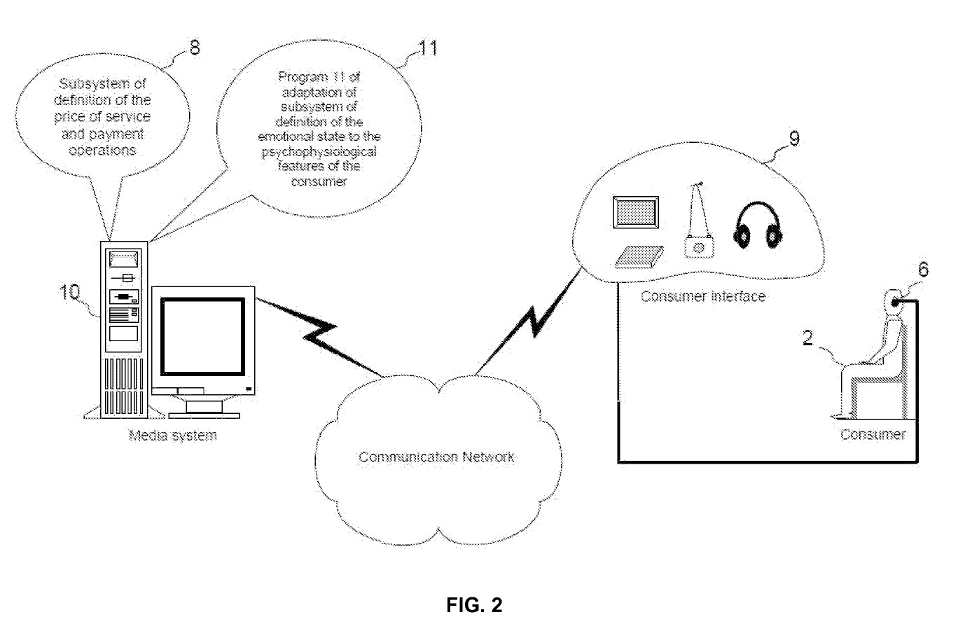

FIG. 2 depicts a variant of the embodiment of entertaining media service consumed by the consumer 2 with the help of the consumer interface 9 is shown. The consumer interface 9 is connected via communication network with one or several media systems 10. The media system 10 provides consumer 2 with an entertaining service with a predetermined (high) index of enjoyment (service previously provided to consumer) or a new entertainment service. If during the delivery of a new entertaining service the consumer does not experience an increase in enjoyment, then the delivery of the service ends.

Entertaining service is delivered to the consumer for money (for example, monthly fee) or for a mutual exchange of services, such as consumer granting provider a permission to show commercial advertisements during the entertainment service consumption. Media system 10 includes a subsystem for determination of price of service and payment processing 8. The subsystem for determination of price of service and payment processing 8 performs the following functions: detecting the emotional state of the consumer during the entire time of consumption of an entertaining service; monetary settlements with consumers; calculation of the payment to the owner of the media system and/or payment to the author (artist).

Consumer 2 attaches the sensor of the emotional state 6 on his body or clothes at the place of consumption of the entertainment service. Sensor 6 may also be built into the seat, into the device with which consumer interfaces or into any place of a compartment. Media system 10 includes program 11 for adaptation of subsystem of determining the emotional state to the psycho-physiological features of a consumer. Psycho-physiological features of a consumer are: presence or absence of biologically active points (zones) on the body of the person, intensity or dullness of particular reactions of the consumer's organism, the possibility or the impossibility of detecting any parameters of physiological reactions, individual properties of organism, etc. Program 11 should allow for adaptation of subsystem for determining the emotional state to specific features of a consumer.

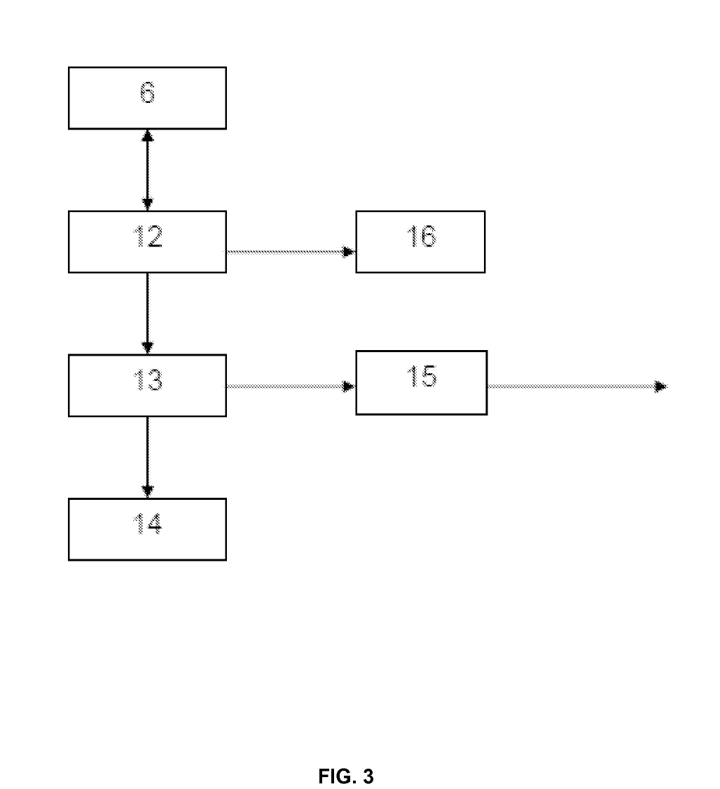

FIG. 3 depicts a variant of the embodiments of system for selling services to consumers. System includes sensor 6 of subsystem for determination of emotional state 12. Subsystem for determination of the emotional state 12 detects the “zero” (neutral) emotional state of the consumer and estimates changes of the emotional state of the consumer during entire delivery of the entertaining service to him.

Subsystem of evaluation of entertaining service by consumers 13 performs evaluation of a separate creation by an author (artist), determines the total value (rating) of an author (artist) and the total value (rating) of the entire creation. Subsystem of calculating the price of the service and payment processing 14 performs monetary settlements of consumers with authors (artists) and/or with suppliers of entertaining services. Subsystem 15 provides connection with an association of owners of entertaining services or with other systems of a higher level. System also has a database 16, in which various data about consumers of entertaining services is collected.

Entering of definitions of concrete technologies:

The above detailed description of the invention and the examples described herein have been provided for the purposes of illustration and description. It is therefore contemplated to cover by the present invention, any and all modifications, variations or equivalents that fall within the spirit and scope of the basic underlying principles disclosed and claimed herein.

What is claimed is:

1. A method for selling a service to a consumer, the method comprising:
delivering the service,
determining an emotional state of the consumer within one or more of the following time periods: before a consumption of the service, during the consumption of the service, and after the consumption of the service,
setting a price for the service based on the emotional state, and
receiving a payment from the consumer in an amount of the set price.

2. The method of claim 1, wherein the service is an entertainment service.

3. The method of claim 1, wherein a main goal of the service is to increase a degree of pleasure of the consumer.

4. The method of claim 1, wherein the consumer pays the price prior to receiving the service.

5. The method of claim 4, wherein the price is a payment made by the consumer.

6. The method of claim 4, wherein the amount of the price is determined after delivering the service.

7. The method of claim 6, wherein the consumer is returned a portion of the payment or pays an additional amount of money.

8. The method of claim 6, wherein the payment is made by transferring the amount of the set price to an account after the service is received.

9. The method of claim 1, wherein the consumer pays after the service is received.

10. The method of claim 1, wherein the maximum range of prices is communicated to the consumer prior to receiving the service.

11. The method of claim 1, wherein prices corresponding to emotional states are communicated to the consumer prior to delivering the service.

12. The method of claim 1, wherein the emotional state of the consumer is compared to a neutral emotional state.

13. The method of claim 12, wherein the neutral emotional state is the neutral emotional state of the consumer.

14. The method of claim 12, wherein the neutral emotional state is an average of a neutral emotional state.

15. The method of claim 12, wherein the neutral emotional state is defined prior to delivering the service.

16. The method of claim 1, wherein receiving the payment from the consumer is via a uniform entertainment card.

17. A system for selling consumer services, the system comprising a sub-system for determining an emotional state of the consumer within one or more of the following time periods: before a consumption of the service, during the consumption of the service, and after the consumption, the emotional state being used for setting a price for the service.

18. The system of claim 17, wherein the service is an entertainment service.

19. The system of claim 17, wherein the sub-system for determining the emotional state of the consumer further comprises at least one detector of an emotional state.

20. The system of claim 17, wherein the determination of an emotional state is facilitated by one or more of the following: a contact method and a contactless methods.

21. The system of claim 17, wherein the sub-system for determining an emotional state of the consumer further comprises adapting the subsystem to psychological and physiological features of the consumer.

22. The system of claim 17, wherein the emotional state is determined by monitoring at least one of the following: a facial gesture, facial movement, third party evidence.

23. The system of claim 17, wherein the emotional state is based on tangible values, a change in the tangible values reflecting a change in the emotional state.

24. The system of claim 23, wherein the adopting of the subsystem to the psychological and physiological features of the consumer further comprises determining of a neutral emotional state based on physiological parameters of the consumer.

25. The system of claim 17, further comprising a sub-system for delivering the service.

26. The system of claim 25, wherein the sub-system for delivering the service comprises one or more of the following: a media device and a communication device.

27. The system of claim 25, wherein the sub-system for delivering the service comprises an outdoor entertainment facility.

28. The system of claim 17, further comprising a pricing and payment sub-system.

29. The system of claim 28, wherein the pricing and payment sub-system processes consumer information and facilitates payments for entertainment services.

30. The system of claim 29, wherein the processing of the consumer information further comprises identification of the consumer.

31. The system of claim 29, wherein the processing of the consumer information further comprises programming a fixation of the emotional states during consumption of a single entertainment service.

32. The system of claim 29, wherein the pricing and payment sub-system further calculates the price of the service.

33. The system of claim 29, wherein the pricing and payment sub-system further calculates an income due an owner of the entertainment service and a royalty due to a performer.
